(19) United States
(12) Patent Application Publication
(10) Pub. No.: US 2017/0289025 A1
(43) Pub. Date: Oct. 5, 2017

(54) Tagging Mechanism and Out-of Sequence Packet Delivery for QoS Enhancement

(71) Applicant: MEDIATEK INC., Hsinchu (TW)

(72) Inventors: Ming-Yuan Cheng, Taipei City (TW); Chia-Chun Hsu, New Taipei City (TW); Pavan Santhana Krishna Nuggehalli, Mountain View, CA (US); Per Johan Mikael Johansson, Kungsangen (SE)

(21) Appl. No.: 15/473,887

(22) Filed: Mar. 30, 2017

Related U.S. Application Data
(60) Provisional application No. 62/316,613, filed on Apr. 1, 2016.

(51) Int. Cl. H04L 12/725; H04L 29/12; H04L 29/06; H04L 1/00

(52) U.S. Cl. CPC H04L 45/302; H04L 1/0018; H04L 61/2007; H04L 69/22; H04L 69/324

(57) ABSTRACT

A tagging mechanism supporting different QoS categories for IP/Port services in a cellular radio network is proposed. Tags are used to differentiate different types of services and corresponding QoS requirements. At the sender side, the sender of the IP packets is able to distinguish different types of services by tagging one or multiple bits for finer QoS control. For downlink IP traffic, the tagging function can be done at the base station. For uplink IP traffic, the tagging function can be done at the UE. At the receiver side, the receiver delivers the IP packets using out-of-sequence delivery for delay sensitive packets. With tagging and out-of-sequence delivery, the delay sensitive packets can reduce CN latency and transmission latency.

### CROSS REFERENCE TO RELATED APPLICATIONS

This application claims priority under 35 U.S.C. §119 from U.S. Provisional Application No. 62/316,613 entitled “Out-of-sequence for QoS Enhancement” filed on Apr. 1, 2016, the subject matter of which is incorporated herein by reference.

### TECHNICAL FIELD

The disclosed embodiments relate generally to wireless communication, and, more particularly, to tagging mechanism and out-of-sequence packet delivery for Quality of Service (QoS) enhancement.

### BACKGROUND

Long Term Evolution (LTE), commonly marketed as 4G LTE, is a standard for wireless communication of high-speed data for mobile phones and data terminals. LTE is based on Global System for Mobile Communications (GSM) and Universal Mobile Telecommunication System (UMTS) technologies that provides higher data rate, lower latency and improved system capacity. In LTE systems, an evolved universal terrestrial radio access network (E-UTRAN) includes a plurality of base stations, referred as evolved Node-Bs (eNBs), communicating with a plurality of mobile stations, referred as user equipments (UEs).

In LTE systems, all IP traffic of different services on over-the-top (OTT) application are delivered over a default data radio bearer (DRB). The default DRB does not support finer granularity quality of service (QoS) for different services. For example, delay sensitive packets like UDP packets are carried by the same default DRB as delay tolerance packets like TCP packets. If UDP is used in real-time chatting services while multiplexing with other TCP services, then the delay-sensitive UDP service may not meet its QoS requirement and have a degraded service quality.

Finer QoS granularity is thus desired to support different IP/Port services.

### SUMMARY

A tagging mechanism supporting different QoS categories for IP/Port services in a cellular radio network is proposed. Tags are used to differentiate different types of services and corresponding QoS requirements. At the sender side, the sender of the IP packets is able to distinguish different types of services by tagging one or multiple bits for finer QoS control. For downlink IP traffic, the tagging function can be done at the base station. For uplink IP traffic, the tagging function can be done at the UE. At the receiver side, the receiver delivers the IP packets using out-of-sequence delivery for delay sensitive packets. With tagging and out-of-sequence delivery, the delay sensitive packets can reduce CN latency and transmission latency.

In one embodiment, a receiving device establishes a radio connection supporting an Internet Protocol (IP) service over an IP connection in a cellular radio network. The receiving device receives an IP packet over the radio connection from a transmitting device of the cellular radio network. The IP packet comprises a sequence number and a layer-2 tag field belonging to a radio protocol stack. The receiving device determines a QoS category based on the tag field of the IP packet. The receiving device processes the IP packet using in-sequence delivery if the IP packet is delay tolerance. Otherwise, the UE processes the IP packet using out-of-sequence delivery if the IP packet is delay sensitive.

In another embodiment, a transmitting device establishes a radio connection supporting an Internet Protocol (IP) service over an IP connection in a cellular radio network. The transmitting device obtains an IP packet from an IP application server/client. The IP packet contains an indication of a QoS category of the IP packet. The transmitting device inserts a sequence number and a tag field into the IP packet. The tag field belongs to a radio protocol stack and indicates the QoS category of the IP packet. The transmitting device transmits the IP packet to a receiving device over the radio connection of the cellular radio network.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a system diagram of a cellular radio network with a tagging mechanism in accordance with embodiments of the current invention.

FIG. 2 illustrates simplified block diagram of a user equipment (UE) in accordance with embodiments of the current invention.

FIG. 3 illustrates an LTE architecture with protocol stacks supported by a UE, an eNB, a SGW/PGW, and a remote host.

FIG. 4 illustrates one embodiment of a tagging procedure in downlink and uplink transmission.

FIG. 5 illustrates a first embodiment of eNB for tagging downlink packet.

FIG. 6 illustrates a second embodiment of UE for tagging uplink packet.

FIG. 7 illustrates a first embodiment of inserting a tag field in PDCP layer.

FIG. 8 illustrates a second embodiment of inserting a tag field in RLC layer.

FIG. 9 illustrates one embodiment of out-of-sequence (OOS) activation procedure.

FIG. 10 illustrates one example of out-of-service (OOS) packet delivery in a cellular radio network with a tagging mechanism.

FIG. 11 illustrates a first embodiment of an OOS receiver.

FIG. 12 illustrates a second embodiment of an OOS receiver.

FIG. 13 is a flow chart of a tagging mechanism supporting different QoS categories for IP traffic in a cellular radio network from receiver perspective in accordance with one novel aspect.

FIG. 14 is a flow chart of a tagging mechanism supporting different QoS categories for IP traffic in a cellular radio network from transmitter perspective in accordance with one novel aspect.

### DETAILED DESCRIPTION

Reference will now be made in detail to some embodiments of the invention, examples of which are illustrated in the accompanying drawings.

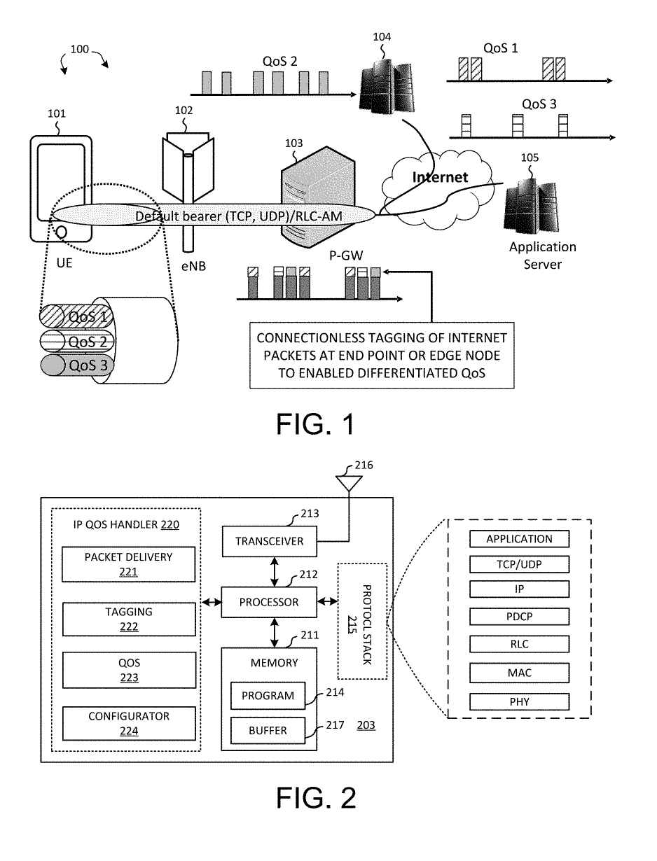

FIG. 1 illustrates a system diagram of a cellular radio network 100 with a tagging mechanism in accordance with embodiments of the current invention. Cellular radio network 100 comprises a user equipment UE 101, a base station eNB 102, a packet gateway PGW 103, and application servers 104 and 105. In LTE systems, different data radio bearers (DRBs) including a default DRB and multiple dedicated DRBs are used for different application services. For example, a dedicated DRB is used for voice over LTE (VoLTE) service provided by an IMS server. However, all IP traffic of different services on over-the-top (OTT) applications are delivered over a default data radio bearer (DRB). The default DRB does not support finer granularity QoS for different services.

In the example of FIG. 1, application server 104 provides a first application service to UE 101 with QoS1 requirement, and a second application service to UE 101 with QoS2 requirement. Application server 105 provides a third application service to UE 101 with QoS3 requirement. All three application services are delivered over the default bearer (TCP, UDP) on top of RLC-AM. For example, delay sensitive packets like UDP packets are carried by the same default DRB as delay tolerance packets like TCP packets. If UDP is used in real-time chatting services while multiplexing with other TCP services, then the delay-sensitive UDP service may not meet its QoS requirement and have a degraded service quality.

In accordance with a novel aspect, indicators like tags can be used to differentiate different types of services and corresponding QoS requirements. The sender is able to distinguish different types of services by tagging one or multiple bits for finer QoS control. In the example of FIG. 1, for downlink IP traffic, the tagging function can be done at P-GW 103 or at eNB 102. For uplink IP traffic, the tagging function can be done at UE 101. For example, at the sender side, QoS1 packets, QoS2 packets, and QoS3 packets are tagged with different tagging bits. At the receiver side, the receiver delivers the different IP packets using out-of-sequence (OOS) delivery for delay sensitive packets. With tagging and OOS delivery, those delay sensitive packets can reduce CN latency and transmission latency.

FIG. 2 illustrates simplified block diagram of a user equipment (UE) 203 in accordance with embodiments of the current invention. UE 203 has radio frequency (RF) transceiver module 213, coupled with antenna 216, receives RF signals from antenna 216, converts them to baseband signals and sends them to processor 212. RF transceiver 213 also converts received baseband signals from the processor 212, converts them to RF signals, and sends out to antenna 216. Processor 212 processes the received baseband signals and invokes different functional modules to perform features in UE 203. Memory 211 stores program instructions 214 and buffer 217 and other data to control the operations of UE 203.

UE 203 also includes multiple function modules and circuits that carry out different tasks in accordance with embodiments of the current invention. The different function modules and circuits can be configured and implemented using hardware, firmware, software, and combinations thereof. UE 203 includes an IP QoS handler 220, which further comprises a packet delivery circuit 221, a tagging circuit 222, a QoS handling circuit 223, and a configuration module 224. In one example, the packet delivery circuit 221 performs in-sequence or out-of-sequence delivery based on the tag field of the IP packets. Tagging circuit 222 inserts a tag field to each IP packet based on the corresponding QoS category. QoS circuit 223 determines the QoS category for the IP packets associated with the IP service. Configurator 224 configures various configuration including packet tagging and delivery. UE 203 further includes a protocol stack 215, which further comprises different layers including PHY, L2-layer (MAC, RLC, PDCP, new AS sublayer, etc.), IP, TCP/UDP, and Application layer.

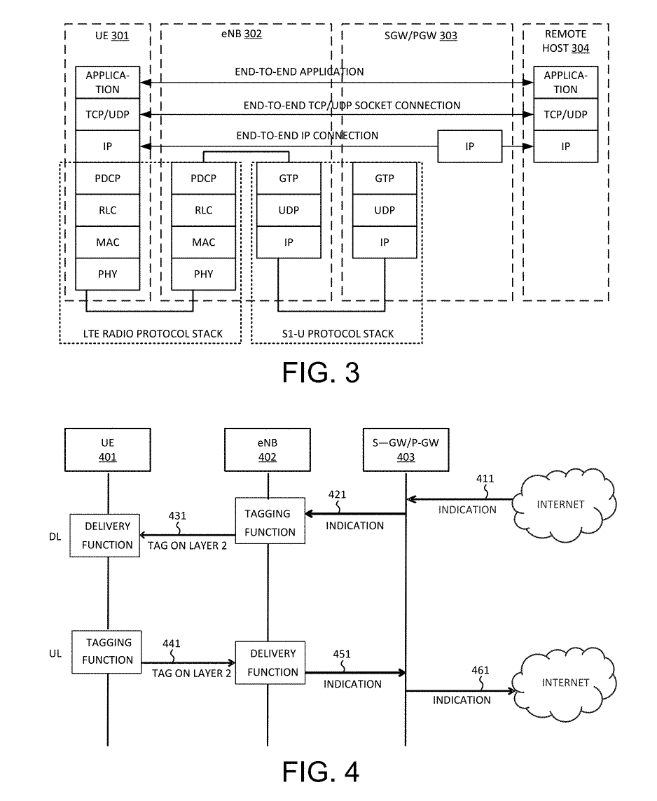

FIG. 3 illustrates an LTE architecture with protocol stacks supported by a UE 301, an eNB 302, a SGW/PGW 303, and a remote host 304. In the LTE system, UE 301 is served by eNB 302 for radio access to the core network (CN) and then to application servers such as remote host 304 for IP services. At the application layer, an end-to-end application service is established between UE 301 and host 304. At the TCP/UDP layer, an end-to-end TCP/UDP socket connection is established between UE 301 and host 304. At the IP layer, an end-to-end IP connection is established between UE 301 and host 304. For lower layers, UE 301 and serving eNB 302 communicate over LTE radio protocol stack, including physical layer (PHY) and layer 2 (MAC, RLC and PDCP). Serving eNB 302 and SGW/PGW 303 communicate over S1-U protocol stack, including IP, UDP, and GTP layers. For downlink IP traffic, the tagging function can be done at the PGW 303 or at eNB 302. For uplink IP traffic, the tagging function can be done at UE 301. The IP packets can be tagged at Layer 2 of the radio protocol stack, e.g., PDCP layer or RLC layer or new AS sublayer, converting from protocols (e.g., TCP or UDP) used and port number, or from IP packets classification rules from the core network.

FIG. 4 illustrates one embodiment of a tagging procedure in downlink and uplink transmission in an LTE cellular radio network. In the cellular radio network, UE 401 establishes an end-to-end IP connection with a remote host over the Internet for different services. For downlink traffic, in step 411, an IP packet with indication is sent from the remote host to SGW/PGW 403. The indication indicates the QoS requirement of the IP packet. In step 421, the IP packet with indication is forwarded from the SWG/PGW to eNB 402. The indication indicates the QoS requirement of the IP packet. In one embodiment, the tagging function can be performed by the eNB. The eNB tags the IP packet on Layer 2 (e.g., PDCP layer or RLC layer, new AS sublayer, etc.) based on the QoS requirement of the IP packet. In step 431, the tagged IP packet is sent from the eNB to UE 401. Upon receiving the IP packet, the UE checks the tag field of the IP packet and determines delivery mode, e.g., in-sequence delivery for delay tolerant packet or out-of-sequence delivery for delay sensitive packet.

Similarly, for uplink traffic, in step 441, an IP packet with indication is sent from UE 401 to eNB 402. The UE tags the IP packet on Layer 2 (e.g., PDCP layer or RLC layer, new AS sublayer, etc.) based on the QoS requirement of the IP packet. Upon receiving the IP packet, the eNB checks the tag field of the IP packet and determines delivery mode, e.g., in-sequence delivery for delay tolerant packet or out-of-sequence delivery for delay sensitive packet. In step 451, the IP packet is forwarded from the eNB to SGW/PGW 403 with indication. In step 461, the IP packet is sent from the SGW/PGW to the remote host over the Internet with indication. The first embodiment of indication can use DSCP/ECN (Differentiated Services Code Point/Explicit Congestion Notification) field in IP layer to distinguish different services. The second embodiment of indication can be one or multiple bits to distinguish different services.

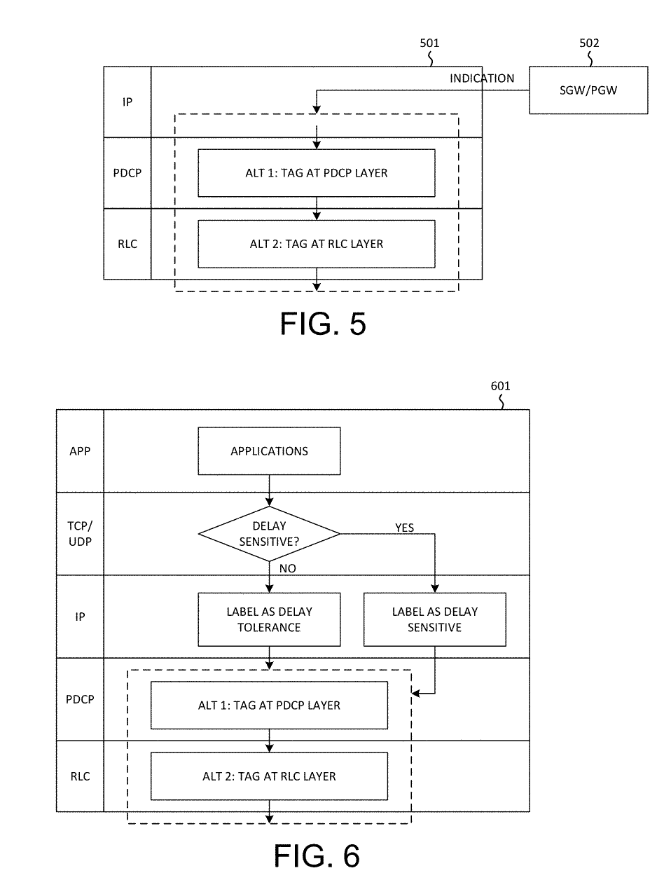

FIG. 5 illustrates a first embodiment of tagging by an eNB 501 for downlink packets. Base station eNB 501 comprises an IP layer, a PDCP layer, and an RLC layer. For downlink packets, eNB 501 receives indication for tagging from a serving gateway or PDN gateway SGW/PGW 502. For example, from IP layer, the indication indicates the packet service type for each DL packet, and eNB 501 can make differentiation on delay sensitivity of each DL packet and perform tagging accordingly. The tagging can be performed in Layer 2 (RLC, PDCP, new AS sublayer etc.).

FIG. 6 illustrates a second embodiment of tagging by a UE 601 for uplink packets. UE 601 comprises an application layer, a TCP/UDP layer, an IP layer, a PDCP layer, and an RLC layer. For uplink packets, UE 601 obtains indication for tagging based on upper layer information. In a first example, UE 601 receives indication from TCP/UDP layer. UE 601 checks protocol used at transport layer and notifies lower layer. TCP implies delay tolerance, and UDP implies delay sensitive. In a second example, UE 601 receives indication from IP layer. UE 601 checks packet service type for each packet and makes differentiation on delay sensitive and delay tolerant packet. UE 601 can use DSCP/ECN (Differentiated Services Code Point/Explicit Congestion Notification) to distinguish or add one or more bits to indicate packet service type (delay sensitive or delay tolerant). The tagging can be performed in Layer 2 (RLC, PDCP, new AS sublayer etc.).

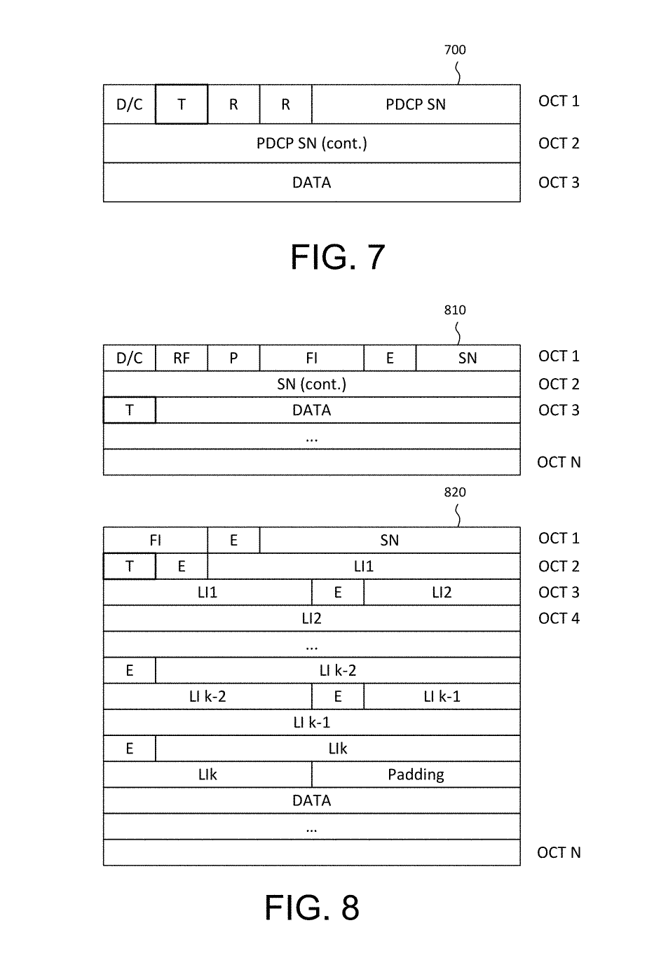

FIG. 7 illustrates a first embodiment of inserting a tag field in PDCP layer. A packet 700 with a PDCP header is depicted in FIG. 7. In the example of packet 700, the base station (for DL packet) or UE (for UL packet) checks packet service type and tag with T field in the PDCP header. For example, for delay-sensitive packet, the T field is set to 1; for delay-tolerant packet, the T field is set to 0.

FIG. 8 illustrates a second embodiment of inserting a tag field in RLC layer. In the example of packets 810 and 820, the base station (for DL packet) or UE (for UL packet) checks packet service type and tag with T field in the RLC header. For example, for delay-sensitive packet, the T field is set to 1; for delay-tolerant packet, the T field is set to 0.

In order to support finer granularity QoS control for different IP services, not only the sender at end point or edge node needs to tag each IP packet based on its QoS requirement, the receiver also needs to deliver the IP packets based the tagging information. Specifically, out-of-sequence delivery needs to be supported. Out-of-sequence delivery means that a PDU or a packet can be delivered to upper layer without waiting for other packets, i.e., no need to wait for lost packets or delayed packets with smaller sequence number. The concept of out-of-sequence delivery is that the receiver side (e.g., UE for downlink and eNB for uplink) can deliver different service types of packets by different operation modes by identifying tags. For example, for DL parts, receiver side (e.g., UE) can deliver PDU to upper layer more quickly once identify the PDU belongs to delay sensitive service. For UL parts, receiver side (e.g., eNB) can deliver PDU to upper layer more quickly once identify the PDU belongs to delay sensitive service. With tags, receiver can deliver delay sensitive PDUs quickly. Further, the delay sensitive PDUs can avoid HOL (Head-Of-Line) blocking problem because there is no need to wait for other type of PDU.

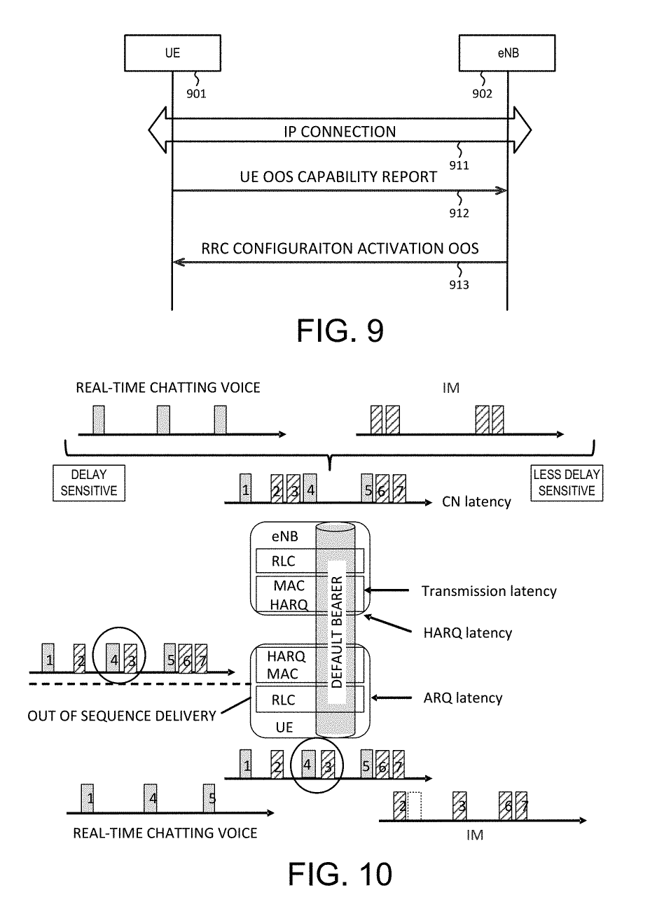

FIG. 9 illustrates one embodiment of out-of-sequence (OOS) activation procedure. Not all UE supports out-of-sequence (OOS) delivery. In addition, a UE may not want to activate the OOS capability all the time. Therefore, the OOS capability needs to be communicated with its serving base station and activated or deactivated accordingly. In the example of FIG. 9, in step 911, UE 901 and eNB 902 establish an IP connection for providing different IP services. In step 912, UE 901 sends a UE OOS capability report to eNB 902. The OOS capability report informs eNB 902 that UE 901 supports OOS delivery capability. In step 913, eNB 902 sends an RRC configuration message to UE 901 to activate the OOS operation. Upon activation, UE 901 can perform OOS delivery by identifying tags.

FIG. 10 illustrates one example of out-of-service (OOS) packet delivery in a cellular radio network with a tagging mechanism. In the example of FIG. 10, two types of IP traffic are delivered from eNB to UE. A first type of IP traffic is delay sensitive, e.g., for real-time chatting voice (as depicted by grey shade). A second type of IP traffic is less delay sensitive, e.g., for instant message (IM) (as depicted by slashed shade). Both IP traffic are delivered over the same default DRB of the cellular radio network. When the two types of IP packets arrive at the eNB after CN latency, the eNB labels each IP packet with a sequence number based on its arrival time, e.g., packet 1, 2, 3, 4, 5, 6, and 7. Among the IP packets, packets 1, 4, 5 belong to the first chatting service, while packets 2, 3, 6, 7 belong to the second IM service. The IP packets then reach the UE after additional transmission latency, HARQ latency, and ARQ latency. The IP packets arrive at the UE in the order of packets 1, 2, 4, 3, 5, 6 and 7. Particularly, IP packet 3 incurred a longer delay than other packets and arrives at the UE after IP packet 4.

In accordance with one novel aspect, the IP packets are tagged by the eNB according to its QoS requirements. For example, IP packets 1, 4, 5 are tagged as delay sensitive packets, and IP packets 2, 3, 6, 7 are tagged as delay tolerance packets. When the UE receives the IP packets from the physical layer, the UE examines each packet and check the tag field. If the tag field indicates the packet is delay tolerant, then the UE waits for in-sequence delivery. On the other hand, if the tag field indicates the packet is delay sensitive, then the UE delivers the packet to upper layer without waiting for packets with smaller sequence numbers. As a result, the upper layer of the UE receives IP packets 1, 4, 5 in a timely manner for the real-time chatting service. For example, packet 4 is delivered quickly without waiting for packet 3. The QoS requirement for the real-time chatting is satisfied. On the other hand, the upper layer of the UE receives IP packets 2, 3, 6, and 7 in-sequence delivery, with IP packet 3 having a bit longer delay. Since the IM service is delay tolerant, its QoS requirement is also satisfied with the longer delay.

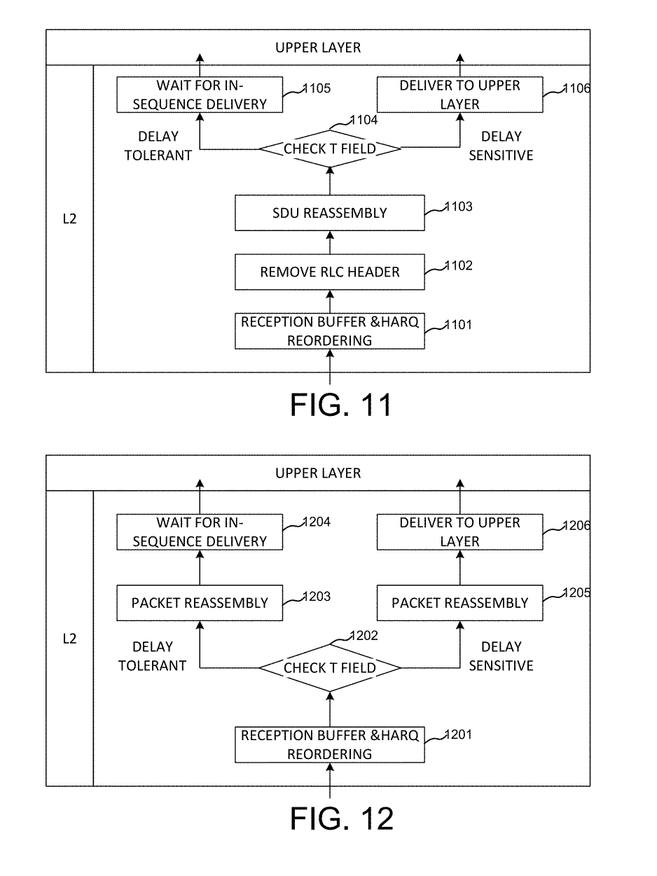

FIG. 11 illustrates a first embodiment of an OOS receiver. The OOS receiver comprises layer 2 (L2) and upper layers. In step 1101, the OOS receiver receives a PDU from lower layer, e.g., PHY layer, stores in a reception buffer and performs HARQ reordering. In step 1102, the OOS receiver removes the RLC header. In step 1103, the OOS receiver performs SDU reassembly. In step 1104, the OOS receiver checks whether this SDU is delay sensitive by checking the T field. If the SDU is delay tolerant, in step 1105, the OOS receiver waits for in-sequence delivery. If the SDU is delay sensitive, in step 1106, the OOS receiver delivers the SDU to upper layer immediately without waiting for other SDUs.

FIG. 12 illustrates a second embodiment of an OOS receiver. The OOS receiver comprises L2 and upper layers. In step 1201, the OOS receiver receives a PDU from lower layer, e.g., PHY layer, stores in a reception buffer and performs HARQ reordering. In step 1202, the OOS receiver checks whether this PDU is delay sensitive or not by checking the T field. If the PDU is delay tolerant, in step 1203, the OOS receiver performs packet reassembly. In step 1204, the OOS receiver waits for in-sequence delivery. If the SDU is delay sensitive, in step 1205, the OOS receiver performs packet reassembly. In step 1206, the OOS receiver delivers the packet to upper layer immediately without waiting for other packets.

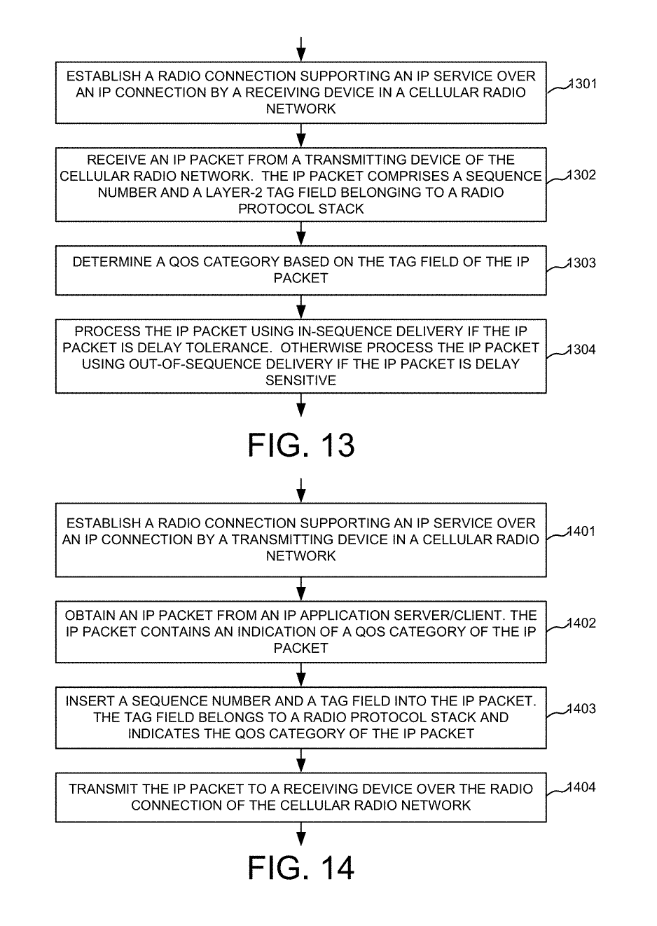

FIG. 13 is a flow chart of a tagging mechanism supporting different QoS categories for IP traffic in a cellular radio network from receiver perspective in accordance with one novel aspect. In step 1301, a receiving device establishes a radio connection supporting an Internet Protocol (IP) service over an IP connection in a cellular radio network. In step 1302, the receiving device receives an IP packet over the radio connection from a transmitting device of the cellular radio network. The IP packet comprises a sequence number and a layer-2 tag field belonging to a radio protocol stack. In step 1303, the receiving device determines a QoS category based on the tag field of the IP packet. In step 1304, the receiving device processes the IP packet using in-sequence delivery if the IP packet is delay tolerance. Otherwise, the UE processes the IP packet using out-of-sequence delivery if the IP packet is delay sensitive.

FIG. 14 is a flow chart of a tagging mechanism supporting different QoS categories for IP traffic in a cellular radio network from transmitter perspective in accordance with one novel aspect. In step 1401, a transmitting device establishes a radio connection supporting an Internet Protocol (IP) service over an IP connection in a cellular radio network. In step 1402, the transmitting device obtains an IP packet from an IP application server/client. The IP packet contains an indication of a QoS category of the IP packet. In step 1403, the transmitting device inserts a sequence number and a tag field into the IP packet. The tag field belongs to a radio protocol stack and indicates the QoS category of the IP packet. In step 1404, the transmitting device transmits the IP packet to a receiving device over the radio connection of the cellular radio network.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
establishing a radio connection supporting an Internet Protocol (IP) service over an IP connection by a receiving device in a cellular radio network;
receiving an IP packet from a transmitting device of the cellular radio network, wherein the IP packet comprises a sequence number and a layer-2 tag field belonging to a radio protocol stack;
determining a QoS category based on the tag field of the IP packet; and
processing the IP packet using in-sequence delivery if the IP packet is delay tolerance, otherwise processing the IP packet using out-of-sequence delivery if the IP packet is delay sensitive.

2. The method of claim 1, wherein the IP connection is established over a default radio bearer of the cellular radio network.

3. The method of claim 1, wherein the tag field is contained in a packet data convergence protocol (PDCP) header.

4. The method of claim 1, wherein the tag field is contained in a radio link control (RLC) header.

5. The method of claim 1, wherein the QoS category comprises at least a delay tolerance category and a delay sensitive category.

6. The method of claim 1, wherein the receiving device is a user equipment (UE) and sends a UE capability report to a serving base station, wherein the UE capability indicates that the UE supports out-of-sequence delivery.

7. A receiving device, comprising:
a radio protocol stack handling circuit that establishes a radio connection supporting an Internet Protocol (IP) service over an IP connection in a cellular radio network;
a radio frequency (RF) receiver that receives an IP packet from a transmitting device of the cellular radio network, wherein the IP packet comprises a sequence number and a layer-2 tag field belonging to a radio protocol stack;
a quality of service (QoS) handling circuit that determines a QoS category based on the tag field of the IP packet; and
a packet delivery circuit that delivers the IP packet using in-sequence delivery if the IP packet is delay tolerance, otherwise delivers the IP packet using out-of-sequence delivery if the IP packet is delay sensitive.

8. The device of claim 7, wherein the IP connection is established over a default radio bearer of the cellular radio network.

9. The device of claim 7, wherein the tag field is contained in a packet data convergence protocol (PDCP) header.

10. The device of claim 7, wherein the tag field is contained in a radio link control (RLC) header.

11. The device of claim 7, wherein the QoS category comprises at least a delay tolerance category and a delay sensitive category.

12. The device of claim 7, wherein the device is a user equipment (UE) and sends a UE capability report to a serving base station, wherein the UE capability indicates that the UE supports out-of-sequence delivery.

13. A method comprising:
establishing a radio connection supporting an Internet Protocol (IP) service over an IP connection by a transmitting device in a cellular radio network;
obtaining an IP packet from an IP application server or from an IP application client, wherein the IP packet contains an indication of a QoS category of the IP packet;
inserting a tag field into the IP packet, wherein the tag field belongs to a radio protocol stack and indicates the QoS category of the IP packet; and
transmitting the IP packet to a receiving device over the radio connection of the cellular radio network.

14. The method of claim 13, wherein the IP connection is established over a default radio bearer of the cellular radio network.

15. The method of claim 13, wherein the tag field is contained in a packet data convergence protocol (PDCP) header.

16. The method of claim 13, wherein the tag field is contained in a radio link control (RLC) header.

17. The method of claim 13, wherein the QoS category comprises at least a delay tolerance category and a delay sensitive category.

18. A transmitting device, comprising:
a radio protocol stack handling circuit that establishes a radio connection supporting an Internet Protocol (IP) service over an IP connection in a cellular radio network;
an IP layer handling circuit that obtains an IP packet from an IP application server or from an IP application client, wherein the IP packet contains an indication of a QoS category of the IP packet;
a tagging circuit that inserts a tag field into the IP packet, wherein the tag field belongs to a radio protocol stack and indicates the QoS category of the IP packet; and
a radio frequency (RF) transmitter that transmits the IP packet to a receiving device over the radio connection of the cellular radio network.

19. The device of claim 18, wherein the IP connection is established over a default radio bearer of the cellular radio network.

20. The device of claim 18, wherein the tag field is contained in a packet data convergence protocol (PDCP) header.

21. The device of claim 18, wherein the tag field is contained in a radio link control (RLC) header.

22. The device of claim 18, wherein the QoS category comprises at least a delay tolerance category and a delay sensitive category.
